(19) United States
(12) Patent Application Publication
(10) Pub. No.: US 2026/0264626 A1
(43) Pub. Date: Sep. 10, 2026

(54) PILLAR GARNISH AND MANUFACTURING METHOD THEREOF

(71) Applicant: TOKAI KOGYO CO., LTD., Obu-shi (JP)

(72) Inventor: Motohiro MORISHITA, Aichi (JP)

(73) Assignee: TOKAI KOGYO CO., LTD., Obu-shi (JP)

(21) Appl. No.: 19/557,970

(22) Filed: Mar. 5, 2026

(30) Foreign Application Priority Data
Mar. 6, 2025 (JP) 2025-035725

(51) Int. Cl. B60R 13/02

(52) U.S. Cl. CPC B60R 13/025

(57) ABSTRACT

A pillar garnish includes: a body portion that includes a head portion and a first leg portion; a cushion portion that is joined to at least one side end edge of the head portion; an end cover portion that includes a protruding piece portion protruding toward a center side of the body portion in a longitudinal direction of the body portion at an end of the body portion; and a second leg portion that is formed separately from the body portion, and that is fixed to at least a part of a portion of a back surface of the head portion where the first leg portion is not formed. At least a part of the second leg portion in the longitudinal direction is adjacent to the protruding piece portion of the end cover portion in a width direction of the pillar garnish.

### CROSS-REFERENCE TO RELATED APPLICATIONS

This application is based upon and claims the benefit of priority from prior Japanese patent application No. 2025-035725 filed on Mar. 6, 2025, the entire contents of which are incorporated herein by reference.

### BACKGROUND

### 1. Field of the Invention

The present disclosure relates to a pillar garnish and a manufacturing method thereof.

### 2. Description of the Related Art

In the related art, a pillar garnish is known as one of molded products in the field of automobiles. The pillar garnish is generally a long molded product attached to a gap between a side end portion of a window plate of a vehicle body and a pillar of the vehicle body along the side end portion of the window plate.

As this type of pillar garnish and a manufacturing method thereof, for example, JP2007-76317A discloses that an end cover portion is molded at a lower end portion of a garnish body portion in the longitudinal direction by injection molding simultaneously with an inward cushion portion and an outward cushion portion.

However, in the pillar garnish as described in JP2007-76317A, when a part of the end cover portion protrudes outward and is formed in a shape adjacent to an attachment portion, a problem occurs. That is, even if the end cover portion, the inward cushion portion, and the outward cushion portion are to be injection-molded at the same time, since the slide die of the injection molding die comes into contact with a part of the end cover portion, the injection molding die cannot be opened and molding cannot be performed. In the future, from the viewpoint of vehicle design or the like, it is expected that the protruding piece portion protruding from the end cover portion needs to be long, and the end cover portion cannot be molded as it is, or the shape of the injection molding die becomes complicated even if the end cover portion can be molded. The degree of freedom of the shape of the end cover portion is also limited.

### SUMMARY

The present disclosure has been made in consideration of such problems, and an object of the present disclosure is to provide a pillar garnish in which the shape of an injection molding die does not become complicated, in which an end cover portion including a protruding piece portion can be injection-molded, and in which the degree of freedom of the shape of the end cover portion can be increased, and a manufacturing method thereof.

According to an aspect of the present disclosure, there is provided a pillar garnish that is attached to a gap between a side end portion of a window plate of a vehicle body and a pillar of the vehicle body along the side end portion of the window plate, the pillar garnish including: a body portion that includes a head portion covering the gap from an outside of the vehicle body and a first leg portion protruding from a back surface side of the head portion, and that is formed in a long shape; a cushion portion that is joined to at least one side end edge of the head portion of the body portion; an end cover portion that is joined integrally to an end of the body portion continuously from the cushion portion, and that includes a protruding piece portion protruding toward a center side of the body portion in a longitudinal direction of the body portion at the end of the body portion; and a second leg portion that is formed separately from the body portion, and that is fixed to at least a part of a portion of a back surface of the head portion where the first leg portion is not formed, in which at least a part of the second leg portion in the longitudinal direction is adjacent to the protruding piece portion of the end cover portion in a width direction of the pillar garnish.

In the pillar garnish, the second leg portion may include: a base portion fixed to the back surface of the head portion of the body portion; and a reinforcing portion integrally connected to the base portion and fixed to a back surface of the end cover portion.

In the pillar garnish, the second leg portion may be clinched and fixed to the head portion of the body portion.

According to another aspect of the present disclosure, there is provided a manufacturing method for the pillar garnish according to claim 1, the manufacturing method including: a cavity forming step of setting the body portion in an injection molding die including at least a first molding die and a second molding die movable relative to the first molding die, and then closing the injection molding die to form a molding cavity for molding the cushion portion and the end cover portion; a joining step of, after the molding cavity is formed, causing a heated and melted polymer material to flow into the molding cavity, filling the molding cavity with the polymer material to mold the cushion portion and the end cover portion, and integrally joining the cushion portion and the end cover portion to the body portion; and a die opening step of opening the injection molding die.

The manufacturing method for the pillar garnish may further include a fixing step of fixing the second leg portion to the head portion of the body portion in a molded body released from the injection molding die.

The manufacturing method for the pillar garnish may further include a fixing step of clinching and fixing the second leg portion to the head portion of the body portion in the molded body released from the injection molding die.

In the pillar garnish according to the first invention, at least a part of the second leg portion in the longitudinal direction is adjacent to the protruding piece portion of the end cover portion in the width direction of the pillar garnish. However, in the pillar garnish according to the first invention, since the second leg portion is separate from the body portion, the second leg portion may not be integrated with the body portion before the cushion portion and the end cover portion are joined to the body portion by injection molding at the time of manufacturing the pillar garnish. Therefore, in the pillar garnish according to the first invention, when the injection molding die that injection-molds the cushion portion and the end cover portion is opened, the injection molding die can be prevented from coming into contact with the protruding piece portion of the end cover portion. Therefore, in the pillar garnish according to the first invention, the shape of the injection molding die does not become complicated, and the end cover portion including the protruding piece portion can be injection-molded, and the degree of freedom of the shape of the end cover portion can be increased.

In the pillar garnish according to the second invention, in addition to the effect of the pillar garnish according to the first invention, the reinforcing portion integrally connected to the base portion of the second leg portion fixed to the back surface of the head portion of the body portion can be fixed to the back surface of the end cover portion. Therefore, the end cover portion can be reinforced by the reinforcing portion.

In the pillar garnish according to the third invention, in addition to the effect of the pillar garnish according to the first invention or the second invention, since the second leg portion is clinched and fixed to the head portion of the body portion, the second leg portion can be easily and firmly fixed to the head portion of the body portion.

In the manufacturing method for the pillar garnish according to the fourth invention, when the cushion portion and the end cover portion are joined to the body portion by injection molding, since the second leg portion is not integrated with the body portion, when an injection molding die that injection-molds the cushion portion and the end cover portion is opened, the injection molding die can be prevented from coming into contact with the protruding piece portion of the end cover portion. Therefore, in the manufacturing method for the pillar garnish according to the fourth invention, the shape of the injection molding die does not become complicated, and the end cover portion including the protruding piece portion can be injection-molded.

In the manufacturing method for the pillar garnish according to the fifth invention, in addition to the effect of the manufacturing method for the pillar garnish according to the fourth invention, since the second leg portion is fixed to the head portion of the body portion in the molded body released from the injection molding die, the pillar garnish having a large degree of freedom in the shape of the end cover portion can be more reliably manufactured.

In the manufacturing method for the pillar garnish according to the sixth invention, in addition to the effects of the manufacturing method for the pillar garnish according to the fourth invention or the fifth invention, the second leg portion is clinched and fixed to the head portion of the body portion in the molded body released from the injection molding die. Therefore, the second leg portion can be easily and firmly fixed to the head portion of the body portion.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a perspective view showing a state in which a pillar garnish according to an embodiment is attached to a vehicle body;

FIG. 2 is a plan view of the pillar garnish according to the embodiment;

FIG. 3 is a side view of the end portion of the pillar garnish according to the embodiment as viewed from an arrow III direction;

FIG. 4 is a cross-sectional view taken along a line IV-IV of the pillar garnish according to the embodiment;

FIG. 5 is a cross-sectional view taken along a line V-V of the pillar garnish according to the embodiment;

FIG. 6 is a perspective view of a second leg portion of the pillar garnish according to the embodiment;

FIG. 7 is a cross-sectional view showing a cross section (a portion corresponding to the cross section taken along the line IV-IV in FIG. 4) in a state in which the injection molding die is closed after the body portion is set in the injection molding die;

FIG. 8 is a cross-sectional view showing a cross section (a portion corresponding to the cross section taken along the line V-V in FIG. 5) in a state in which the injection molding die is closed after the body portion is set in the injection molding die; and

FIG. 9 is a cross-sectional view showing, corresponding to FIG. 8, a problem occurring when the injection molding die is opened in a case in which the second leg portion is fixed to the head portion of the body portion before a cushion portion and an end cover portion are injection-molded to the body portion.

### DETAILED DESCRIPTION OF THE INVENTION

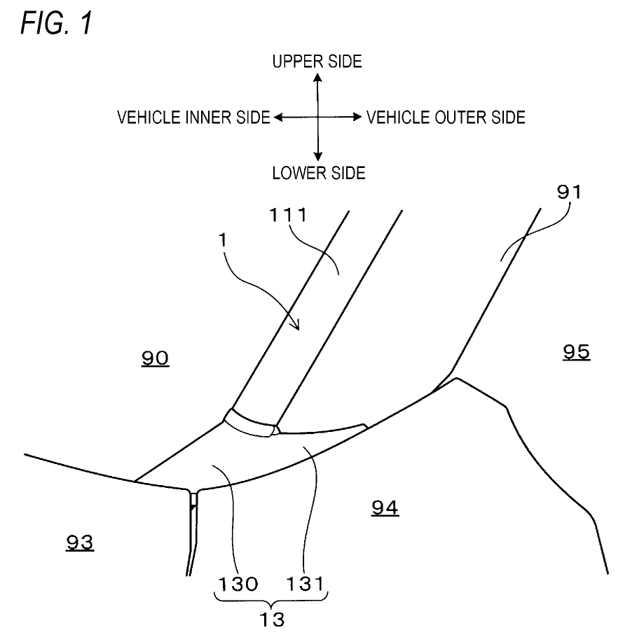

A pillar garnish and a manufacturing method thereof according to an embodiment will be described in detail with reference to FIGS. 1-9. In the following, a case will be described as an example in which a window plate is a front window plate (a front window glass) on the front surface of the vehicle body and a pillar of the vehicle body is an A pillar. The same applies to a case in which the window plate is a rear window plate (a rear window glass) on the rear surface of the vehicle body and the pillar of the vehicle body is a rearmost pillar (also referred to as a C pillar, a D pillar, or the like depending on the vehicle type) when the vehicle body is viewed from the side.

### Pillar Garnish

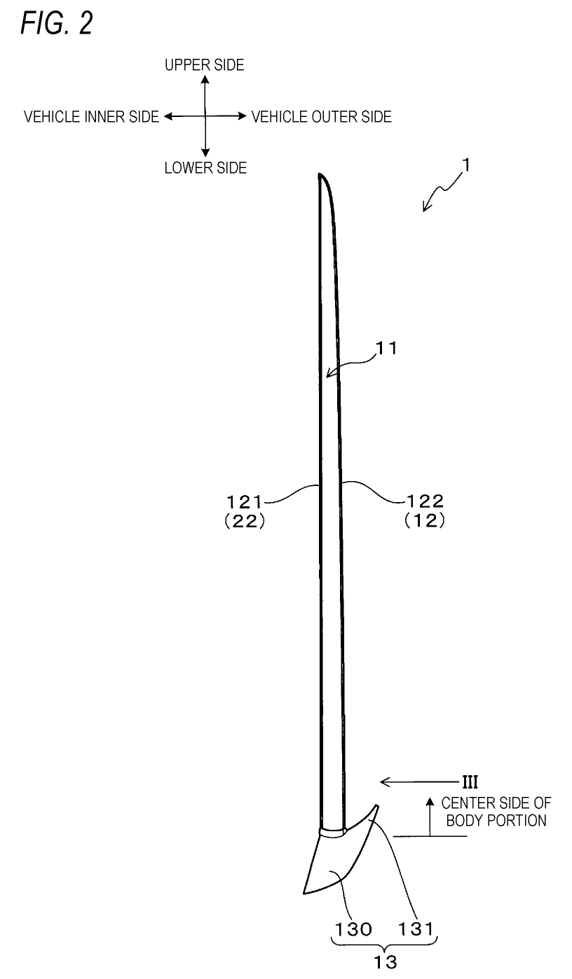

A pillar garnish according to an embodiment will be described in detail with reference to FIGS. 1-6. As illustrated in FIGS. 1, 4, and 5, a pillar garnish 1 according to the present embodiment is attached to a gap 92 between a side end portion of a window plate 90 of a vehicle body and a pillar 91 of the vehicle body along the side end portion of the window plate 90. Reference signs 93, 94, and 95 shown in FIG. 1 denote a bonnet panel, a fender panel, and a side door panel, respectively, which are parts of the vehicle body panel. As illustrated in FIG. 2, the pillar garnish 1 has a long shape having a longitudinal direction.

As illustrated in FIGS. 1-6, the pillar garnish 1 includes a body portion 11, a cushion portion 12, an end cover portion 13, and a second leg portion 14.

The body portion 11 is a portion formed in a long shape. That is, the body portion 11 can also be said to be an elongated molded body constituting the body portion of the pillar garnish 1. The body portion 11 includes a head portion 111 and a first leg portion 112.

The head portion 111 is a portion that mainly covers the gap 92 from the outside of the vehicle body. Therefore, the head portion 111 can be formed in a long shape having a predetermined length so as to cover the gap 92 from the outside of the vehicle body.

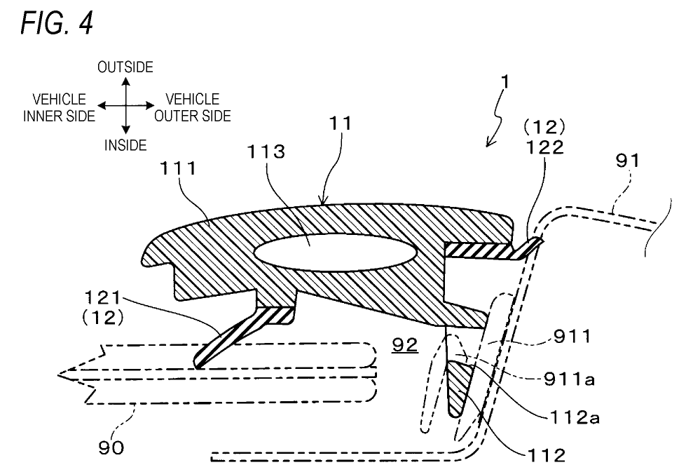

The first leg portion 112 protrudes from the back surface (the inner surface) side of the head portion 111. The first leg portion 112 is a portion used when the pillar garnish 1 is attached along the side end portion of the window plate 90 so as to cover the gap 92 between the side end portion of the window plate 90 of the vehicle body and the pillar 91 of the vehicle body. In the present embodiment, as illustrated in FIG. 4, the pillar garnish 1 is attached to the vehicle body by engaging a clip portion 911 provided on the pillar 91 of the vehicle body with the first leg portion 112.

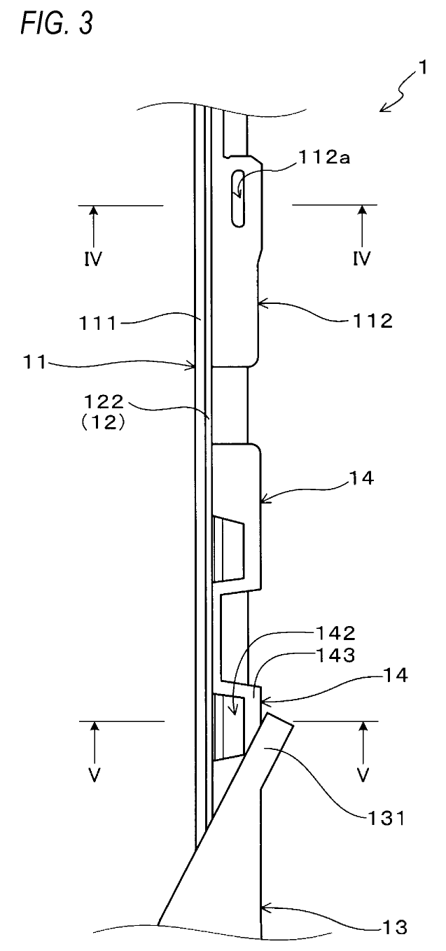

Specifically, as illustrated in FIGS. 3 and 4, the first leg portion 112 can include a first engaging portion 112a into which a claw portion 911a of the clip portion 911 is fitted. In this case, the pillar garnish 1 can be attached to the vehicle body by inserting the first leg portion 112 of the pillar garnish 1 into the clip portion 911 provided on the pillar 91 of the vehicle body and fitting the claw portion 911a of the clip portion 911 into the first engaging portion 112a of the first leg portion 112.

FIGS. 3 and 4 illustrate an example in which the first engaging portion 112a is formed of a through hole penetrating the first leg portion 112. Alternatively, the first engaging portion 112a may be formed of a recess (not illustrated) not penetrating the first leg portion 112. One first engaging portion 112a may be formed in the first leg portion 112, or two or more first engaging portions 112a may be formed in the first leg portion 112. Although not shown, the pillar garnish 1 can also be attached to the vehicle body by fitting a claw portion formed on the first leg portion 112 to a clip side engaging portion formed on the clip portion 911. At least one first leg portion 112 is present in the longitudinal direction of the body portion 11.

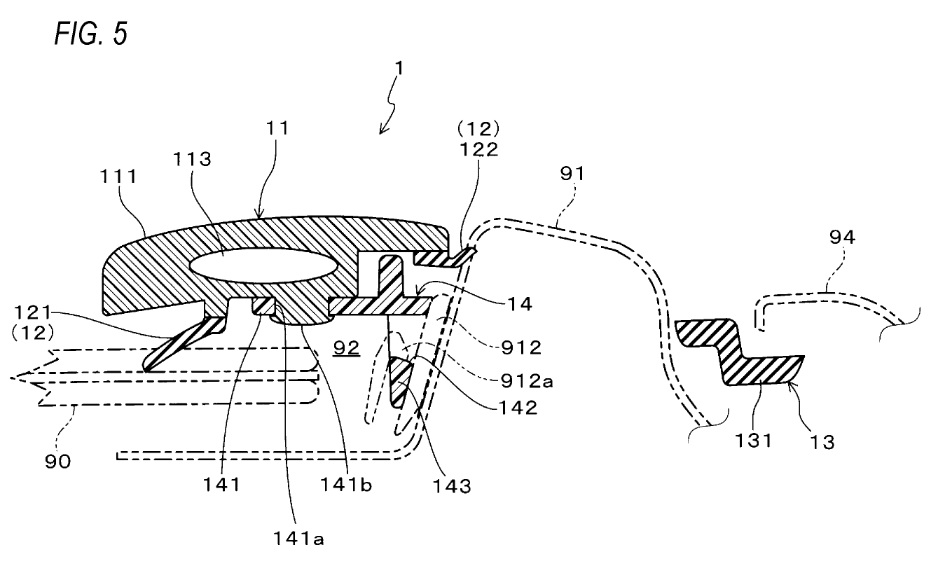

In the present embodiment, it is preferable that the first leg portion 112 is integrally formed with the head portion 111 from the viewpoint that the body portion 11 can be easily molded into a desired shape by gas-assisted injection molding or the like. As illustrated in FIGS. 4 and 5, a hollow portion 113 is present inside the body portion 11 along the longitudinal direction of the body portion 11. The hollow portion 113 is a cavity formed by gas-assisted injection molding. According to the gas-assisted injection molding, it is possible to prevent shrinkage (sink marks) from occurring even when the head portion 111 is formed thick.

As the polymer material (hereinafter, may be referred to as a "polymer material for constituting the body portion") constituting the body portion 11, a hard polymer material or the like having higher rigidity than the cushion portion 12 is suitable. Examples of such polymer materials for constituting the body portion include thermoplastic synthetic resins such as acrylonitrile butadiene styrene resin (ABS), acrylonitrile ethylene propylene styrene resin (AES resin), rigid or semi-rigid polyvinyl chloride resin (PVC resin), polycarbonate resin (PC resin), polypropylene resin (PP resin), polyethylene resin (PE resin), polystyrene resin (PS resin), polyamide resin (PA resin), and poly methyl methacrylate resin (PMMA resin).

The cushion portion 12 is joined to at least one side end edge of the head portion 111 of the body portion 11 by injection molding. The cushion portion 12 may include only a first cushion portion 121 joined to the side end edge of head portion 111 on the vehicle inner side, only a second cushion portion 122 joined to the side end edge of head portion 111 on the vehicle outer side, or both the first cushion portion 121 and the second cushion portion 122. At least the distal end portion of the first cushion portion 121 can come into elastic contact with the outer surface of the window plate 90, and at least the distal end portion of the second cushion portion 122 can come into elastic contact with the outer surface of the pillar 91. FIGS. 2, 4, and 5, show an example in which the cushion portion 12 includes both the first cushion portion 121 and the second cushion portion 122 from the viewpoint of easily preventing rainwater, wind, dust, dirt, and the like from entering the gap 92.

As the polymer material (hereinafter, may be referred to as a "polymer material for constituting the cushion portion") constituting the cushion portion 12, a polymer material or the like having a lower material hardness than the body portion 11 and having flexibility and elasticity is suitable. Examples of polymer materials for constituting such a cushion portion include thermoplastic synthetic resins such as olefin-based thermoplastic elastomer (TPO), styrene-based thermoplastic elastomer (SBC), and soft polyvinyl chloride resin (PVC resin), and rubbers. The polymer material for constituting the cushion portion preferably has compatibility with the polymer material for constituting the body portion from the viewpoint of improving the joining property with the body portion 11.

The end cover portion 13 is integrally joined to the end of the body portion 11 continuously from the cushion portion 12. Specifically, the end cover portion 13 can be integrally joined to the end of the body portion 11 by injection molding continuously from the cushion portion 12. In the present embodiment, the end cover portion 13 covers the lower end portion of the body portion 11 and is integrally coupled to the lower end portions of the first cushion portion 121 and the second cushion portion 122 that serve as the cushion portion 12.

As illustrated in FIGS. 1, 2, 3, and 5, the end cover portion 13 includes a protruding piece portion 131. The protruding piece portion 131 protrudes toward the center side (see FIG. 2) of the body portion 11 in the longitudinal direction (the upper-lower direction in FIG. 2) of the body portion 11 at the end of the body portion 11. Specifically, the end cover portion 13 includes an end cover portion body 130 constituting the body of the end cover portion 13 and the protruding piece portion 131 protruding from one side end edge of the end cover portion body 130. The protruding piece portion 131 protrudes from the one side end edge of the end cover portion body 130 toward the center side of the body portion 11 in the longitudinal direction of the body portion 11 with the end portion of the body portion 11 as a reference position.

In this way, the long protruding piece portion 131 extending toward the center side of the body portion 11 in the longitudinal direction of the body portion 11 is a portion that is not seen in JP2007-76317A cited as the related art. The shape of the protruding piece portion 131 is not particularly limited, and FIGS. 1 and 2 show an example in which the protruding piece portion 131 is formed in a tapered shape tapered toward the distal end of the protruding piece portion 131.

Examples of polymer materials (hereinafter, may be referred to as a "polymer material for constituting an end cover portion") constituting the end cover portion 13 include thermoplastic synthetic resins such as olefin-based thermoplastic elastomer (TPO), styrene-based thermoplastic elastomer (SBC), and soft polyvinyl chloride resin (PVC resin), and rubbers. The polymer material for constituting the end cover portion is preferably the same material as the polymer material for constituting the cushion portion from the viewpoint of integral joining with the cushion portion 12, injection moldability, and the like.

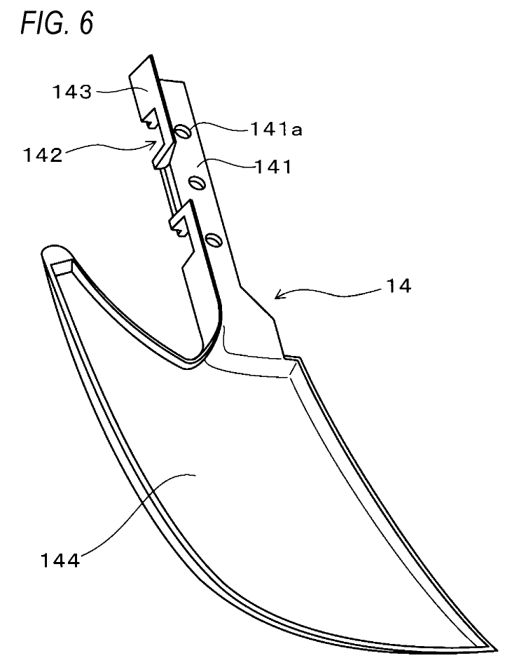

The second leg portion 14 is formed separately from the body portion 11. The second leg portion 14 is fixed to at least a part of a portion of the back surface of the head portion 111 where the first leg portion 112 is not formed. That is, in the pillar garnish 1, the second leg portion 14 formed separately from the body portion 11 is fixed to at least a part of the portion of the back surface of the head portion 111 of the body portion 11 where the first leg portion 112 is not formed, so that the head portion 111 and the second leg portion 14 are connected to each other. As illustrated in FIGS. 5 and 6, the second leg portion 14 can have a base portion 141 fixed to the back surface of the head portion 111 of the body portion 11 from the viewpoint of being easily fixed to the back surface of the head portion 111.

The second leg portion 14 is preferably clinched and fixed to the head portion 111 of the body portion 11 from the viewpoint of easily and firmly fixing the second leg portion 14 to the head portion 111 of the body portion 11. In this case, specifically, at least one protruding portion (not illustrated) is formed on the back surface of the head portion 111 of the body portion 11, and at least one hole 141a for inserting the protruding portion is formed in the base portion 141 of the second leg portion 14 so as to correspond to the protruding portion as illustrated in FIG. 6. Then, the protruding portion is inserted into the hole 141a and the distal end of the protruding portion is crushed to perform thermal clinching for forming a clinching portion 141b as shown in FIG. 5. The position of the hole 141a in the base portion 141 is not particularly limited.

The method for fixing the second leg portion 14 to the head portion 111 of the body portion 11 is not limited to the method described above, and for example, various fixing methods as exemplified below can be used. That is, the second leg portion 14 may be bonded and fixed to the back surface of the body portion 11 by an adhesive, a double-sided tape, or the like, the second leg portion 14 may be bonded and fixed to the back surface of the body portion 11 by a separate clip, rivet, or the like, or the body portion 11 and the second leg portion 14 may be fitted and fixed to each other on the back surface of the body portion 11.

By being fixed to the head portion 111 of the body portion 11, the second leg portion 14 formed separately from the body portion 11 is a portion used when attaching the pillar garnish 1 along the side end portion of the window plate 90 so as to cover the gap 92 between the side end portion of the window plate 90 of the vehicle body and the pillar 91 of the vehicle body, similarly to the first leg portion 112. In the present embodiment, as illustrated in FIG. 5, the pillar garnish 1 is attached to the vehicle body by engaging a clip portion 912 provided on the pillar 91 of the vehicle body with the second leg portion 14.

Specifically, as illustrated in FIGS. 3, 5, and 6, the second leg portion 14 can include a second engaging portion 142 into which a claw portion 912a of the clip portion 912 is fitted. In this case, the pillar garnish 1 can be attached to the vehicle body by inserting the second leg portion 14 of the pillar garnish 1 into the clip portion 912 provided on the pillar 91 of the vehicle body and fitting the claw portion 912a of the clip portion 912 into the second engaging portion 142 of the second leg portion 14.

As illustrated in FIGS. 3, 5, and 6, the second leg portion 14 may be implemented such that a standing wall portion 143 is erected on the base portion 141 and the standing wall portion 143 includes the second engaging portion 142 from the viewpoint of easily engaging with the clip portion 912 provided on the pillar 91 of the vehicle body. The standing wall portion 143 can be erected from a region on the vehicle outer side of the back surface of the base portion 141, a side end surface on the vehicle outer side of the base portion 141, or the like. By forming the second leg portion 14 at a position adjacent to the protruding piece portion 131 of the end cover portion 13, the pillar garnish 1 can be fixed to the vehicle body at the lower end by fitting the second engaging portion 142 to the clip portion 912.

FIGS. 3, 5, and 6 illustrate an example in which the second engaging portion 142 is formed of a through hole penetrating the standing wall portion 143. Alternatively, the second engaging portion 142 may be formed of a recess (not illustrated) or the like not penetrating the standing wall portion 143. One second engaging portion 142 may be formed in the second leg portion 14, or two or more second engaging portions 142 may be formed in the second leg portion 14. Although not shown, the pillar garnish 1 can also be attached to the vehicle body by fitting a claw portion formed on the second engaging portion 142 to a clip side engaging portion formed on the clip portion 912. At least one second leg portion 14 is present in a portion where the first leg portion 112 is not formed in the longitudinal direction of the body portion 11.

As illustrated in FIG. 6, the second leg portion 14 is integrally connected to the base portion 141 and can include a reinforcing portion 144 fixed to the back surface of the end cover portion 13 from the viewpoint of reinforcing the end cover portion 13. The shape of the reinforcing portion 144 is not particularly limited as long as the reinforcing portion 144 can support the end cover portion 13 from the back surface side. FIG. 6 shows an example in which the shape of the reinforcing portion 144 corresponds to the outer shape of the end cover portion 13. More specifically, the reinforcing portion 144 is formed in a shape substantially along the outer shape of the end cover portion 13 such that the reinforcing portion 144 does not protrude when viewed from the surface of the end cover portion 13. The reinforcing portion 144 can be fixed to the back surface of the end cover portion 13 by, for example, bonding with a double-sided tape, an adhesive, or the like.

Examples of polymer materials (hereinafter, may be referred to as a "polymer material for constituting a second leg portion") constituting the second leg portion 14 include thermoplastic synthetic resins such as acrylonitrile butadiene styrene resin (ABS), acrylonitrile ethylene propylene styrene resin (AES resin), rigid or semi-rigid polyvinyl chloride resin (PVC resin), polycarbonate resin (PC resin), polypropylene resin (PP resin), polyethylene resin (PE resin), polystyrene resin (PS resin), polyamide resin (PA resin), and poly methyl methacrylate resin (PMMA resin). The polymer material for constituting the second leg portion is preferably the same material as the polymer material for constituting the body portion from the viewpoint of reducing the number of materials for manufacturing the pillar garnish 1 and sharing materials.

As illustrated in FIGS. 2, 3, and 5, in the pillar garnish 1, at least a part of the second leg portion 14 in the longitudinal direction is adjacent to the protruding piece portion 131 of the end cover portion 13 in the width direction of the pillar garnish 1. That is, when at least a part of the second leg portion 14 in the longitudinal direction is focused on, the pillar garnish 1 has an configuration in which the protruding piece portion 131 of the end cover portion 13 is present in the width direction of the pillar garnish 1 at the focused point.

As described above, although the pillar garnish 1 according to the present embodiment has the configuration described above, since the second leg portion 14 is separate from the body portion 11, the second leg portion 14 is not integrated with the body portion 11 before the cushion portion 12 and the end cover portion 13 are joined to the body portion 11 by injection molding at the time of manufacturing the pillar garnish 1. Therefore, in the pillar garnish 1 according to the present embodiment, when an injection molding die 2 that injection-molds the cushion portion 12 and the end cover portion 13 is opened, the injection molding die 2 can be prevented from coming into contact with the protruding piece portion 131 of the end cover portion 13 (specifically, detailed description will be made with reference to the drawings in the description of (a manufacturing method for a pillar garnish) to be described later). Therefore, in the pillar garnish 1 according to the present embodiment, the shape of the injection molding die 2 does not become complicated, the end cover portion 13 including the protruding piece portion 131 can be injection-molded, and the degree of freedom of the shape of the end cover portion 13 can be increased.

### Manufacturing Method for Pillar Garnish

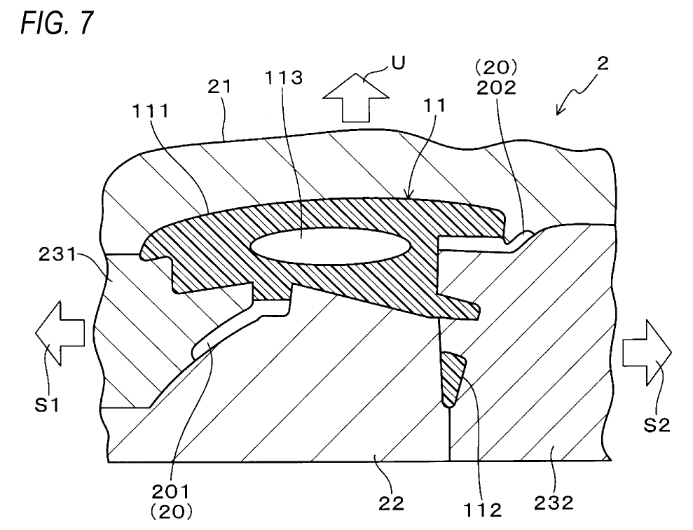

A manufacturing method for a pillar garnish according to the embodiment will be described in detail with reference to FIGS. 7-9. Since the manufacturing method for a pillar garnish according to the embodiment is a manufacturing method for manufacturing the pillar garnish 1 according to the embodiment described above, the description of the pillar garnish 1 according to the embodiment and FIGS. 1-6 can be appropriately referred to as necessary.

The manufacturing method (hereinafter, may be referred to as "the present manufacturing method") for a pillar garnish according to the embodiment includes at least a cavity forming step, a joining step, and a die opening step.

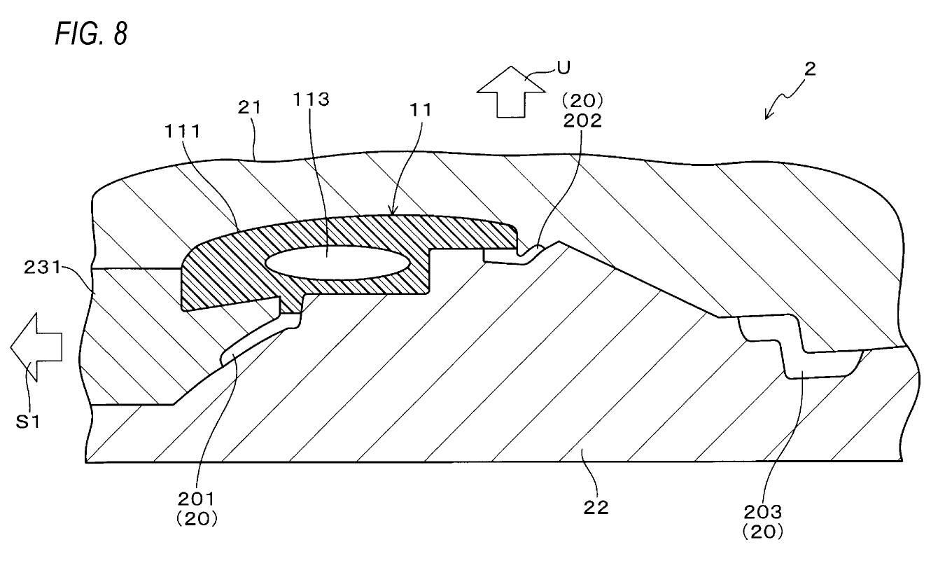

In the present manufacturing method, as illustrated in FIGS. 7 and 8, the cavity forming step is a step of setting the body portion 11 in the injection molding die 2, then closing the injection molding die 2, and forming a molding cavity 20 for molding the cushion portion 12 and the end cover portion 13.

In the present embodiment, since the first cushion portion 121 and the second cushion portion 122 are molded as the cushion portion 12, a first cushion portion cavity 201 for molding the first cushion portion 121, a second cushion portion cavity 202 for molding the second cushion portion 122, and an end cover portion cavity 203 for molding the end cover portion 13 are formed as the molding cavity 20.

The injection molding die 2 includes at least a first molding die 21 and a second molding die 22. The first molding die 21 is movable relative to the second molding die 22. In addition to the first molding die 21 and the second molding die 22, the injection molding die 2 can include at least one slide die that is slidable in a direction intersecting the opening and closing direction of the first molding die 21 and the second molding die 22 as necessary. FIGS. 7 and 8 show an example in which the injection molding die 2 includes a first slide die 231 as a slide die and a second slide die 232 different from the first slide die 231.

Here, the first molding die 21 is described as an upper mold, and the second molding die 22 is described as a lower mold. As shown in FIGS. 7 and 8, the die opening direction of the first molding die 21 serving as the upper mold is an upward direction of an arrow U. The die opening direction of the first slide die 231 is a direction of an arrow S1. The die opening direction of the second slide die 232 is a direction of an arrow S2. The die closing directions of the first molding die 21, the first slide die 231, and the second slide die 232 are all directions opposite to the die opening directions.

In FIGS. 7 and 8, the inner surface of the first molding die 21 is formed in a shape along the surface of the body portion 11, the surface of the second cushion portion 122, and the surface of the end cover portion 13. The inner surface of the second molding die 22 is formed in a shape along a part of the back surface of the body portion 11, a part of the back surface of the first cushion portion 121, a part of the back surface of the second cushion portion 122, and the back surface of the end cover portion 13. The inner surface of the first slide die 231 is formed in a shape along a part of the back surface of the body portion 11 and a part of the front surface of the first cushion portion 121. The inner surface of the second slide die 232 is formed in a shape along a part of the back surface of the body portion 11 and a part of the back surface of the second cushion portion 122.

The first molding die 21 forms a parting line with the second molding die 22, the first slide die 231, and the second slide die 232. The second molding die 22 forms a parting line with the first molding die 21, the first slide die 231, and the second slide die 232. The first slide die 231 forms a parting line with the first molding die 21 and the second molding die 22. The second slide die 232 forms a parting line with the first molding die 21 and the second molding die 22.

In the injection molding die 2, the first cushion portion cavity 201 is formed by the second molding die 22 and the first slide die 231. The second cushion portion cavity 202 is formed by the first molding die 21, the second molding die 22, and the second slide die 232. The end cover portion cavity 203 is formed by the first molding die 21 and the second molding die 22. That is, the second slide die 232 serving as a slide die is not used to form the end cover portion cavity 203.

In the present manufacturing method, the joining step is a step of causing a heated and melted polymer material to flow into the molding cavity 20 after the molding cavity 20 is formed, filling the molding cavity 20 with the polymer material to mold the cushion portion 12 and the end cover portion 13, and integrally joining the cushion portion 12 and the end cover portion 13 to the body portion 11.

Examples of the heated and melted polymer material include those obtained by heating and melting the polymer material for constituting a cushion portion and the polymer material for constituting an end cover portion described above. In the present embodiment, since the cushion portion 12 and the end cover portion 13 are molded by one injection molding, the polymer material for constituting a cushion portion and the polymer material for constituting an end cover portion are the same material.

After the molding cavity 20 is filled with the heated and melted polymer material, the state is maintained for a predetermined time, so that the cushion portion 12 and the end cover portion 13 having shapes corresponding to the cavity shape of the molding cavity 20 can be molded.

In the present manufacturing method, the die opening step is a step of opening the injection molding die 2.

Specifically, in the joining step, the cushion portion 12 and the end cover portion 13 are molded, the cushion portion 12 and the end cover portion 13 are integrally joined to the body portion 11, and then the closed injection molding die 2 is opened. Here, as illustrated in FIG. 7, in the molding region without the end cover portion 13, the first molding die 21 is opened in the direction of the arrow U, the first slide die 231 is opened in the direction of the arrow S1, and the second slide die 232 is opened in the direction of the arrow S2. On the other hand, as illustrated in FIG. 8, in a molding region including the end cover portion 13, the first molding die 21 is opened in the direction of the arrow U, and the first slide die 231 is opened in the direction of the arrow S1.

In the manufacturing method for a pillar garnish according to the present embodiment described above, the second leg portion 14 is not fixed to the body portion 11 when the cushion portion 12 and the end cover portion 13 are joined to the body portion 11 by injection molding. Therefore, when the injection molding die 2 that injection-molds the cushion portion 12 and the end cover portion 13 is opened, the injection molding die 2 can be prevented from coming into contact with the protruding piece portion 131 of the end cover portion 13.

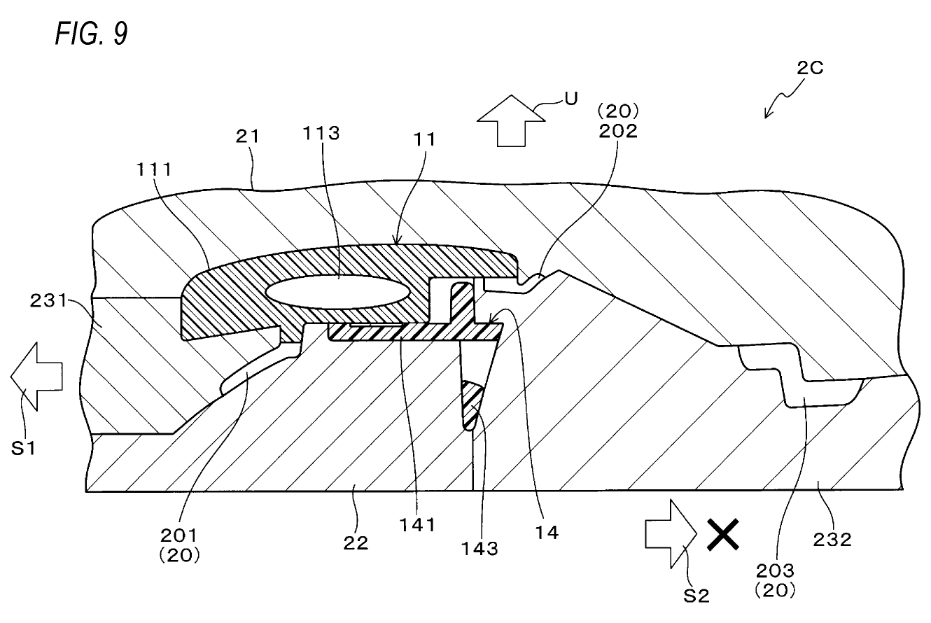

This point will be described more specifically with reference to FIGS. 8 and 9. In a case in which the second leg portion 14 is fixed to the head portion 111 of the body portion 11 before the cushion portion 12 and the end cover portion 13 are injection-molded to the body portion 11, an injection molding die 2C having a die structure as shown in FIG. 9 is used. That is, since the second leg portion 14 is fixed to the head portion 111 of the body portion 11 before injection molding, in order to form the second cushion portion cavity 202, a part of the die needs to enter between the second cushion portion cavity 202 and the second leg portion 14. That is, the second slide die 232 as shown in FIG. 7 is essential so that the pillar garnish 1 can be taken out from the second molding die 22. However, even if the portion described above can be molded by the second slide die 232, in order to obtain a structure in which at least a part of the second leg portion 14 in the longitudinal direction is adjacent to the protruding piece portion 131 of the end cover portion 13 in the width direction of the pillar garnish 1, at least a part of the second leg portion 14 in the longitudinal direction and the end cover portion cavity 203 are adjacent to each other. Therefore, the second slide die 232 comes into contact with the protruding piece portion 131 molded in the end cover portion cavity 203 when the die is opened, and the second slide die 232 cannot be opened by sliding in the direction of the arrow S2 (see "x" mark in FIG. 9), and thus cannot be molded.

On the other hand, the die structure of the injection molding die 2 for manufacturing the pillar garnish 1 according to the present embodiment can be, for example, a die structure as illustrated in FIGS. 7 and 8. That is, since the second leg portion 14 is formed separately from the body portion 11, in the cavity forming step in the present manufacturing method, when the cushion portion 12 and the end cover portion 13 are joined to the body portion 11 by injection molding, the body portion 11 to which the second leg portion 14 is not fixed may be set in the injection molding die 2, and the first cushion portion cavity 201, the second cushion portion cavity 202, and the end cover portion cavity 203 may be formed as the molding cavity 20. In particular, as illustrated in FIG. 8 corresponding to FIG. 9, when a portion to which the second leg portion 14 is to be fixed later and the vicinity of the protruding piece portion 131 of the end cover portion 13 are molded, since there is no undercut shape, the second slide die 232 can be made unnecessary, and the second molding die 22 is sufficient. Further, since the second slide die 232 which is slid and opened in the direction of the arrow S2 can be eliminated, the second slide die 232 does not come into contact with the protruding piece portion 131 molded in the end cover portion cavity 203 when the die is opened.

The above description does not mean that the slide die in the injection molding die 2 can be eliminated at all in the present manufacturing method, but means that the second slide die 232 described above can be eliminated when a portion to which the second leg portion 14 is to be fixed later and the vicinity of the protruding piece portion 131 of the end cover portion 13 are molded. Therefore, in order to mold other portions, the injection molding die 2 may include one or a plurality of slide dies slidable in a direction intersecting the opening and closing direction of the first molding die 21 and the second molding die 22 as necessary.

As described above, in the present manufacturing method, the shape of the injection molding die 2 is not complicated, and the end cover portion 13 including the protruding piece portion 131 can be injection-molded.

In the present manufacturing method, the pillar garnish 1 having a structure in which at least a part of the second leg portion 14 in the longitudinal direction is adjacent to the protruding piece portion 131 of the end cover portion 13 in the width direction of the pillar garnish 1 can be obtained by performing the fixing step of fixing the second leg portion 14 to the head portion 111 of the body portion 11 in the molded body released from the injection molding die 2 after the injection molding die 2 is opened.

The fixing of the second leg portion 14 in the fixing step can be performed by, for example, clinching and fixing the second leg portion 14 to the head portion 111 of the body portion 11 in the molded body released from the injection molding die 2. In this case, the second leg portion 14 can be easily and firmly fixed to the head portion 111 of the body portion 11.

For the fixing of the second leg portion 14 in the fixing step, the second leg portion 14 may be fixed to the head portion 111 of the body portion 11 in the molded body released from the injection molding die 2 using an adhesive, a double-sided tape, a separate clip, a separate rivet, or the like, or the second leg portion 14 may be fitted and fixed to the head portion 111.

The description of the pillar garnish and the manufacturing method for a pillar garnish described above can be mutually referred to as necessary, and in this case, the configurations described in the description can be applied alone or in any combination as necessary.

The present disclosure is not limited to the embodiment described above, and various modifications can be made without departing from the gist of the present disclosure. The claims described in the scope of claims at the time of filing the application can be freely combined.

1. A pillar garnish that is attached to a gap between a side end portion of a window plate of a vehicle body and a pillar of the vehicle body along the side end portion of the window plate, the pillar garnish comprising:
a body portion that includes a head portion covering the gap from an outside of the vehicle body and a first leg portion protruding from a back surface side of the head portion, and that is formed in a long shape;
a cushion portion that is joined to at least one side end edge of the head portion of the body portion;
an end cover portion that is joined integrally to an end of the body portion continuously from the cushion portion, and that includes a protruding piece portion protruding toward a center side of the body portion in a longitudinal direction of the body portion at the end of the body portion; and
a second leg portion that is formed separately from the body portion, and that is fixed to at least a part of a portion of a back surface of the head portion where the first leg portion is not formed,
wherein at least a part of the second leg portion in the longitudinal direction is adjacent to the protruding piece portion of the end cover portion in a width direction of the pillar garnish.

2. The pillar garnish according to claim 1,
wherein the second leg portion includes:
a base portion fixed to the back surface of the head portion of the body portion; and
a reinforcing portion integrally connected to the base portion and fixed to a back surface of the end cover portion.

3. The pillar garnish according to claim 1,
wherein the second leg portion is clinched and fixed to the head portion of the body portion.

4. A manufacturing method for the pillar garnish according to claim 1, the manufacturing method comprising:
a cavity forming step of setting the body portion in an injection molding die including at least a first molding die and a second molding die movable relative to the first molding die, and then closing the injection molding die to form a molding cavity for molding the cushion portion and the end cover portion;
a joining step of, after the molding cavity is formed, causing a heated and melted polymer material to flow into the molding cavity, filling the molding cavity with the polymer material to mold the cushion portion and the end cover portion, and integrally joining the cushion portion and the end cover portion to the body portion; and
a die opening step of opening the injection molding die.

5. The manufacturing method for the pillar garnish according to claim 4, further comprising
a fixing step of fixing the second leg portion to the head portion of the body portion in a molded body released from the injection molding die.

6. The manufacturing method for the pillar garnish according to claim 5, further comprising
a fixing step of clinching and fixing the second leg portion to the head portion of the body portion in the molded body released from the injection molding die.
